(19) United States
(12) Patent Application Publication
(10) Pub. No.: US 2012/0055979 A1
(43) Pub. Date: Mar. 8, 2012

(54) WELD MATERIAL IGNITION

(76) Inventor: Fady Ameer Alghusain, Elyria, OH (US)

(21) Appl. No.: 13/266,787

(22) PCT Filed: Apr. 23, 2010
(86) PCT No.: PCT/US10/32166

§ 371 Date: Oct. 28, 2011

Related U.S. Application Data
(60) Provisional application No. 61/173,766, filed on Apr. 29, 2009.

(30) Foreign Application Priority Data
Apr. 29, 2009 (AU) 2009901849

(51) Int. Cl. B23K 31/02; B23K 37/00

(52) U.S. Cl. 228/198; 228/18

(57) ABSTRACT

A weld ignition system includes a wireless receiver that wirelessly receives a weld ignition activation signal. The weld ignition system further includes igniter that ignites a weld ignition material in response to the wireless receiver wirelessly receiving the weld ignition activation signal. The ignited weld ignition material initiates exothermic based welding of a weld material.

### TECHNICAL FIELD

The following generally relates to weld material ignition.

### BACKGROUND

Exothermic welding has become recognized globally as a preferred way to form top quality welding. One benefit of exothermic welding is the low resistance between rigid metallic rods for bonding and grounding applications. Exothermic welded connections generally are immune to thermal conditions which can cause mechanical and compression joints to become loose or corrode. They are also recognized for their durability and longevity. The process fuses together the parts or conductors to provide a molecular bond, with a current carrying capacity equal to that of the conductor. Such connections are widely used in grounding systems enabling the system to operate as a continuous conductor with lower resistivity. Examples of self propagating exothermic reactions for exothermic welding include the CADWELD® process (Erico International Corporation, Solon, Ohio) and the THERMIT® process (Th. Goldschmidt A G, Essex, Germany).

Exothermic welding (exothermic bonding) is a welding process for joining two electrical conductors that employs superheated copper alloy to permanently join the conductors. The process employs an exothermic reaction of a copper thermite composition to heat the copper, and requires no external source of heat or current. The chemical reaction that produces the heat is an aluminothermic reaction between aluminum powder and a mixture of copper oxides (copper(II) oxide and copper(I) oxide), with chemical formula:

3CuO+2Al→3Cu+Al₂O₃+Heat.

This chemical reaction reaches a temperature of 1,400° C. (1,670 K). The reactants are usually supplied in the form of powders, and the reaction was traditionally triggered using a spark from a flint lighter. The aluminum oxide slag that it produces is discarded. The process employs a semi-permanent graphite crucible mould, in which the molten copper, produced by the reaction, flows through the mould and over and around the conductors to be welded, forming an electrically conductive weld between them. When the copper cools, the mould is either broken off or left in place. The weld formed has higher mechanical strength than other forms of weld, and excellent corrosion resistance. It is also highly stable when subject to repeated short-circuit pulses, and does not suffer from increased electrical resistance over the lifetime of the installation.

Exothermic welding is usually used for welding copper conductors but is suitable for welding a wide range of metals, including stainless steel, cast iron, common steel, brass, bronze, and Monel. It is especially useful for joining dissimilar metals. Because of the good electrical conductivity and high stability in the face of short-circuit pulses, exothermic welds are one of the options specified by §250.8 of the United States National Electrical Code for grounding conductors and bonding jumpers. It is the preferred method of bonding, and indeed it is the only acceptable means of bonding copper to galvanized cable. The NEC does not require such exothermically welded connections to be listed or labeled, but some engineering specifications require that completed exothermic welds be examined using X-ray equipment.

Thermite welding is the process of igniting a mix of high energy iron oxide and aluminum powder materials, which produces a molten metal that is poured between the working pieces of metal to form a welded joint. The aluminum reduces the oxide of another metal, most commonly iron oxide, because aluminum is highly reactive, the thermite reaction is described by the following formula:

Fe₂O₃+2Al→2Fe+Al₂O₃+Heat.

Commonly, the reacting composition is iron oxide powder and aluminum powder, ignited at high temperatures. A strongly thermite (heat-generating with temperature of more than 1,400° C. (1,670 K)) reaction occurs that produces through reduction and oxidation a hot mass of molten iron and a slag of refractory aluminum oxide. The molten iron is the actual welding material (after cooling down, it becomes the final welding material); the aluminum oxide is much less dense than the liquid iron and so floats to the top of the reaction, so the set-up for welding must take into account that the actual welding material is on the bottom and covered by floating slag.

Thermite welding is widely used to weld railroad rails. Typically, the ends of the rails are cleaned, aligned flat and true, and spaced accordingly where a mold made of graphite is clamped around the rail ends, and a compressed-gas torch is used to preheat the ends of the rail. The proper amount of thermite with alloying metal is placed in a refractory funnel, and when the rails have reached a sufficient temperature, the thermite is ignited and allowed to react to completion (allowing time for any alloying metal to fully melt and mix, yielding the desired molten steel or alloy). The reaction crucible is then tapped at the bottom (leaving the aluminum oxide in the crucible), the molten steel flows into the mold, fusing with the rail ends and forming the weld. The entire setup is allowed to cool. The mold is removed and the weld is cleaned by chiseling and grinding to produce a smooth joint. Typical time from start of the work until a train can run over the rail is approximately one half hour.

Exothermic welding mixtures are basically a combination of a reductant metal and usually a transition metal oxide. An example is aluminum and copper oxide, which upon ignition supply enough heat to propagate and sustain a reaction within the mixture. It is usually the molten metal product or the heat of this reaction, which is then used to produce a desired result. The CADWELD® process produces, for example, a mixture of molten copper and aluminum oxide or slag. The higher density of the molten copper causes separation from the slag, with the molten copper usually directed by a mold to join or weld copper to copper, copper to steel, or steel to steel. The aluminum oxide slag is removed from the weld connection and discarded. Another common mixture is iron oxide and aluminum. Where only the heat of the reaction is used, the heat may be used to fuse brazing material, for example.

The exothermic reaction produces a large amount of heat. The most common way to contain the reaction, and to produce the weld or joint, has been to contain the reaction in a split graphite mold. Graphite molds have high characteristics of dissipating heat to the surroundings within an acceptable time. A particulate welding material is placed in the mold, and a starting powder is ignited to initiate an exothermic reaction in the material. When the exothermic material is ignited, molten metal is produced and used to produce the joint. After the molten cools down, it become permanent and rigid connection.

Unfortunately, exothermic mixtures of this type do not react spontaneously and need a method of initiating the reaction. This initiation method involves generating enough localized energy to enable the reaction to begin. One method of initiating reaction is that described above, use of a starting powder and an ignition source such as a flint igniter. However, because of the starting powder's low ignition temperature and difficulties in handling and shipping, much effort has been made to find a reliable and low cost alternative ignition system for the exothermic material. A number of electrical systems have been devised which range from simple spark gaps to bridge wires or foils, to much more esoteric devices such as rocket igniters. Such efforts are seen, for example, in U.S. Pat. Nos. 4,881,677; 4,879,452; 4,885,452; 4,889,324; and 5,145,106. For a variety of reasons, but primarily because of power requirements, dependability, and cost, such devices have not succeeded in replacing the standard starting powder/flint gun form of initiating the self-propagating exothermic reactions. Another electrical ignition system is the system disclosed in U.S. Pat. No. 6,553,911, which is incorporated herein by reference in its entirety.

### SUMMARY

Aspects of the application address the above matters, and others.

In one aspect, a weld ignition system includes a wireless receiver that wirelessly receives a weld ignition activation signal. The weld ignition system further includes an igniter that ignites a weld ignition material in response to the wireless receiver wirelessly receiving the weld ignition activation signal. The ignited weld ignition material initiates exothermic based welding of a weld material.

In another aspect, a method includes initiating a self propagating exothermic welding chemical reaction based on wirelessly receiving a weld activation signal.

In another aspect, a weld ignition system includes a transmitter that wirelessly transmits a weld ignition activation signal in response to an input. The weld ignition system further includes a wireless receiver that wirelessly receives the weld ignition activation signal. The weld ignition system further includes an igniter that initiates an exothermic welding application based on the reception of the weld ignition activation signal.

### BRIEF DESCRIPTION OF THE DRAWINGS

The application is illustrated by way of example and not limitation in the figures of the accompanying drawings, in which like references indicate similar elements and in which:

FIG. 1 illustrates an example wireless ignition system.

FIGS. 2 and 3 illustrate a non-limiting embodiment of an ignition device of the example wireless ignition system in connection with a weld material.

FIGS. 4, 5, and 6 illustrate example ignition devices.

FIG. 7 illustrates an example transmitter of the wireless ignition system.

FIG. 8 illustrates an example method.

### DETAILED DESCRIPTION

The following generally relates to wireless ignition of an exothermic chemical reaction in connection with a welding application, or exothermic based welding. Various non-limiting applications include, but are not limited to, forming electrically weld connections, railroad tracks welding, welding two pieces of copper objects, welding two pieces of rail road tracks, etc.

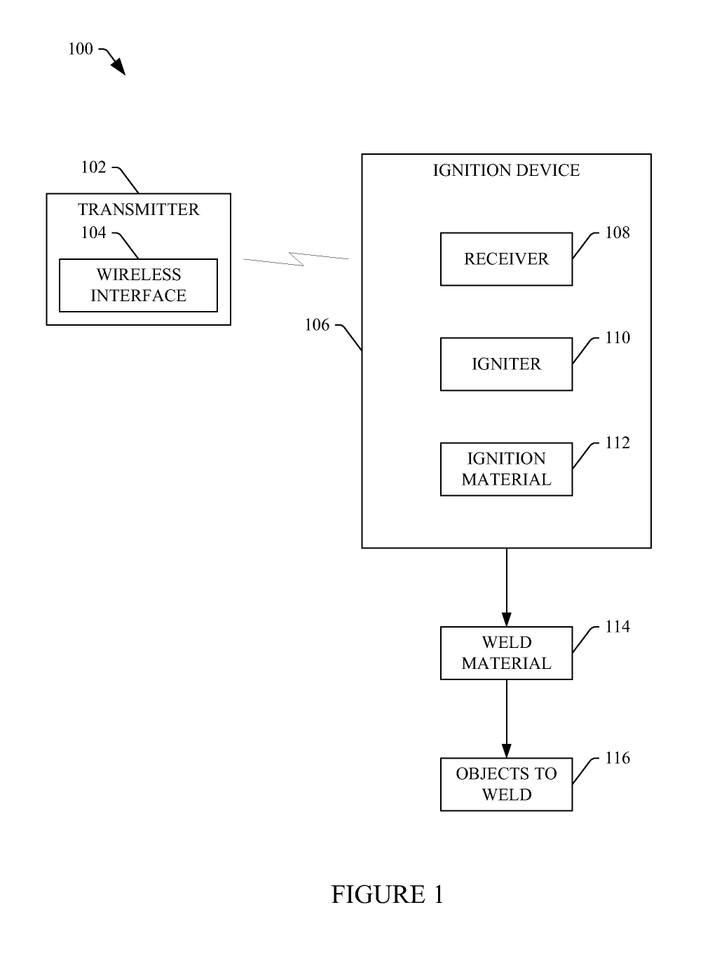

FIG. 1 illustrates an example wireless ignition system 100.

The system 100 includes a transmitter 102. The illustrated transmitter 102 at least includes a wireless interface 104 for wireless communication. Suitable wireless interfaces include, but are not limited to, radio frequency, optical, infrared, laser, and/or other wireless interfaces. Optionally, the transmitter 102 may also include one or more physical electrical contacts for non-wireless communication. In some embodiments, the transmitter 102 also includes a micro-processor that facilitates communication and memory that stores computer readable and executable instructions, which can be executed but the micro-processor, and/or data, which can be used and/or written by the micro-processor. The transmitter 102 can be activated to transmit the signal in response to an input such as a button pressed by a user, a signal from a computing device (e.g., a robot, a computer, etc.), executing microcode, and/or otherwise.

The illustrated wireless interface 104 is configured to transmit at least ignition or weld activation signals. Such transmission may be one to one to a particular predetermined device. In another instance, the wireless interface 104 concurrently or individually transmits signals to two or more devices of a plurality of devices. The wireless interface 104 may also be configured to receive signals Likewise, the wireless interface 104 may be configured to receive signals from only one device or from two or more device of a plurality of devices, concurrently and/or individually. In this context, the transmitter can be considered a transceiver or the like. The transmitter 102 may also include a modulator, a demodulator, an encoder, a decoder, an encrypter, a decrypter, a microcontroller, a microprocessors, a timer, and/or other component(s).

In the illustrated embodiment, an ignition device 106 communicates with the transmitter 102. The ignition device 106 includes a receiver 108, which receives signals such as an ignition activation signal transmitted by the transmitter 102. Such communication can be uni-directional from the transmitter 102 to the ignition device 106 or bi-directional between the transmitter 102 and a transmitter of the ignition device 106. Bi-directional communication may include feedback, a handshake, and/or other communication. The transmitter 102 and receiver 108 may communicate via a unique and/or multiple portions of the electromagnetic spectrum. The receiver 108 may also include a modulator, a demodulator, an encoder, a decoder, an encrypter, a decrypter, and/or other component(s).

An igniter 110, in response to the receiver 108 receiving an ignition activation signal, ignites an ignition material 112 of the ignition device 106. The igniter 110 may include various components including active and/or passive electrical components, an integrated circuit or chip (IC), a application specific integrated circuit (ASIC), and/or other components. Examples of suitable ignition materials include, but are not limited to, an electrical component, a wire, NanoFoil® (Nanofoil Corporation of NY, USA), Nichrome wire, reactive NanoFoil®, silicon oxide wire, other material that release heat, and/or the like. The ignition material can also be replaced using air gap spark technology.

Ignition of the ignition material 112 may cause the ignition material 112 to physically or structurally break apart, such as by exploding, spewing hot material and/or otherwise. Alternatively, the ignition material 112 just produces heat. A weld material 114, in response to the ignited ignition material, ignites or undergoes an exothermic reaction, forming a weld metal or molten. Suitable weld materials include, but are not limited to, mixtures of aluminum oxide and copper and/or other mixture that requires ignition for exothermic welding applications. Another suitable weld material includes a mixture of a reductant metal and a transition metal oxide and ignitable material in an enclosed package. The weld molten is used to weld multiple objects 116 together, such as two or more pieces of metal, ends of metal bars, etc. thereby joining the objects together.

The foregoing approach provides various advantages over conventional manual (e.g., spark) and wired ignition approaches. For example, the wireless approach described herein allows for remote distance ignition without use of wires, a flint gun or the like to ignite a starting powder, and mitigated any need for a starting powder. Where the later may expose the operator to nearby chemical reaction and high temperature dangerous side effects. With the approach described herein, the wireless system operators can be located at a safe distance to perform exothermic welding and control the process without physically being presented near the operation or be limited to the wired ignition system's lead lengths.

Although the receiver 108, the igniter 110, and the ignition material 112 are shown as being part of the igniter 106, in another embodiment one or more of the receiver 108, the igniter 110, and the ignition material 112 are separate from the igniter 106. Where the receiver 108 is separate, the receiver 108 may be placed remote from the ignition device 106 and include electrical leads that connect to the ignition device 106. Moreover, one or more of the receiver 108, the igniter 110, and the ignition material 112 can be included with the weld material 114. Furthermore, the transmitter 102 and/or the igniter 106 can be programmable. The transmitter 102 and/or the igniter 106 may also have various communications ports such as a USB port, a serial port, a parallel port, a firewire port, an Ethernet port, portable memory port, an infrared port, an optical port, etc.

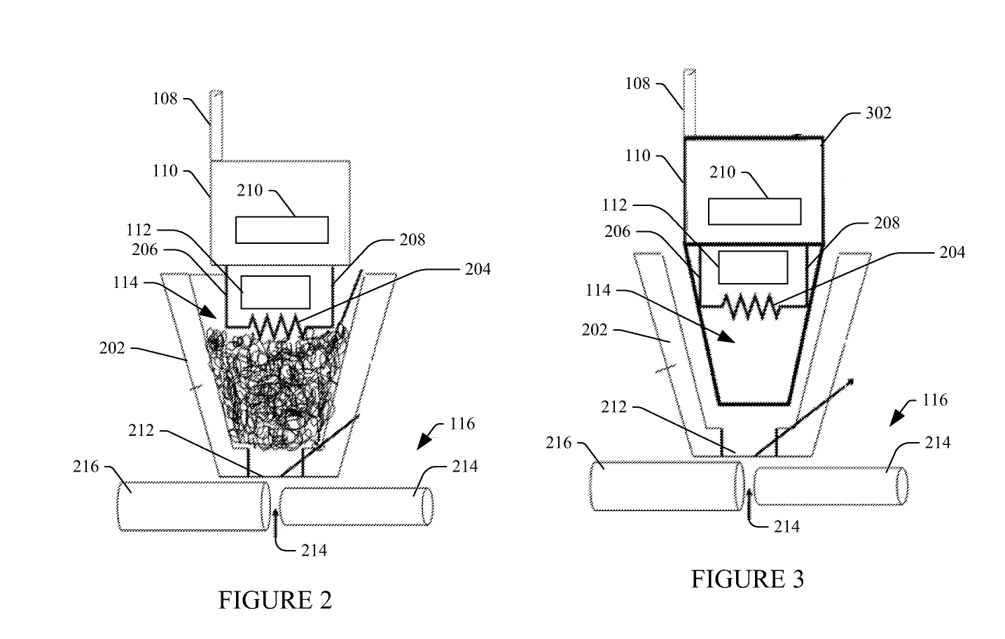

FIG. 2 illustrates a non-limiting embodiment in which the ignition device 106 is used to start an exothermic reaction of a weld material 114 disposed in a mold 202. The mold 202 can be a conventional or traditional graphite or other suitable weld mold. Note that the ignition device 106 may be expendable (e.g., consumed during the weld process) or re-usable.

In this example, the igniter 110 includes a resistive component 204. The illustrated resistive component 204 includes a resister. In other embodiments, resistive component 204 includes other resistive elements such as a transistor, a diode, or other component that absorbs energy and dissipates heat. The igniter 110 further includes one or more electrically conductive paths 206 and 208. The paths 206 and 208 may be electrically conductive traces, wires, or the like.

In the illustrated embodiment, the paths 206 and 208 are in electrical communication with the resistive component 204 and an energy source 210. The igniter 110 supplies an electrical signal (e.g., power, voltage, current, etc.) from the source 210 to the resistive component 204 through the electrically conductive paths 206 and 208. The resistive component 204, in response to receiving the signal, produces heat. In one non-limiting instance, the resistive component 204 explodes, shatters, splinters, break apart, or the like in response to the signal.

The heat produced by and/or fragments of the resistive component 204 ignites the ignition material 112. The ignited ignition material 112 initiates exothermic reaction of the weld material 114. In the illustrated embodiment, the weld material 114 and the resulting weld molten is held in the mold 202 by a temporary holder 214. The temporary holder 214 may include copper, aluminum, steel, iron and/or other material, and melts, opens, dissolves, disintegrates, or the like in response to heat, such as heat produced by the weld molten. The weld molten is used to weld multiple objects 116 together. In the illustrated embodiment, the molten welds first and second metal rods 212 and 214, which may be similar or different materials, the same or different sizes, the same or different shapes, etc.

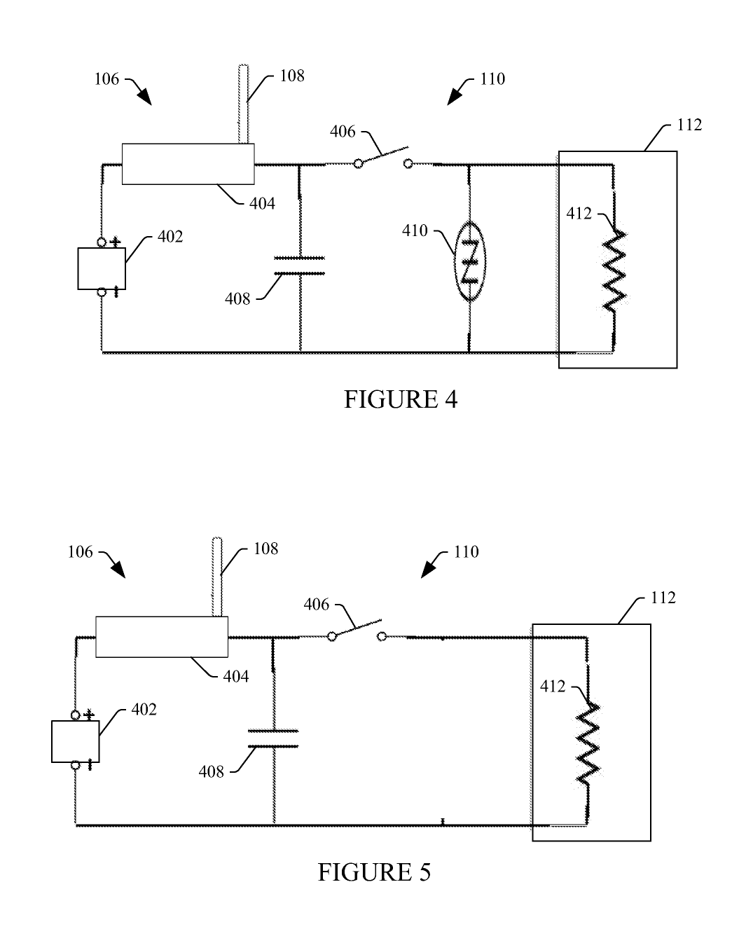

FIG. 3 illustrates a non-limiting embodiment in which the ignition device 106 and the weld material 114 are included in a single package 302. The package may be a non-rigid or rigid container, including a bag, a hard shaped cup, etc. placed in a chamber of the mold 202. In FIGS. 3 and 4, the igniter 106 is partially inside the mold 202. In another embodiment, the igniter 106 is fully inside the mold 202. In another embodiment, the igniter 106 is partially or fully embedded in a side and/or bottom of the mold 202. In another embodiment, the igniter 106 is part of the mold 202.

With respect to FIGS. 2 and 3, in other embodiments, the weld mold 202 is omitted.

FIG. 4 illustrates a non-limiting embodiment of the ignition device 106. In this embodiment, the receiver 108 includes an antenna and a least a portion of the igniter 110 is within the ignition material 112. The igniter 110 includes a power source 402, such as a battery (e.g., a primary cell or secondary (rechargeable) cell), an alternating current (AC) source, or other source of power. The igniter 110 also includes a switch 404, which is activated by receipt of an activation signal by the receiver 108, and a switch 406 that is manually activated by an operator. The illustrated switches are normally open switches. The manual switch 406 can be used to prevent ignition of the ignition material 112 due to inadvertent, malicious, and/or other unauthorized activation of the switch 404.

The igniter 110 also includes a charge storage device 408 such as a capacitor (e.g., air gap, ceramic, film, metallic, energy storage, constant or variable capacitance types, etc.) (as shown), an inductor, a coil, and/or other charge storage device. The igniter 110 also includes a SIDAC (Silicon Diode for Alternating Current) 410 and a resistor 412. Generally, the SIDAC 410 remains non-conducting until the applied voltage meets or exceeds its rated breakover voltage. Once entering this conductive state, the SIDAC 410 continues to conduct, regardless of voltage, until the applied current falls below its rated holding current. At this point, the SIDAC 410 returns to its initial nonconductive state to begin the cycle once again. The SIDAC 410 can be replace with a thyristor, a diode, a transistor, a combination thereof, and/or other component.

In operation, a user places the igniter 110 in the mold 202. The manual switch 406 is closed to enable the igniter 110. Upon receipt of an activation signal from the transmitter 102 by the receiver 108, the switch 402 is closed. The charge storage device 408 stores power from the power source 402. Where the charge storage device 408 is pre-charged, the power source 402 can be omitted. The charge storage device 408 is charged until that charge reaches to the SIDAC 410 pre-set switching voltage. Then the SIDAC 410 discharges the electrical energy into the resister 412. The resistor absorbs the energy and dissipates heat and may also break apart. The heat from the resistor 412 and/or hot pieces of the resistor 412 ignite the ignition material 112, which, as described herein, ignites the weld material 114, which undergoes an exothermic reaction, creating a weld molten used to weld the objects 116.

Another way to view this is that when the switches 406 and 408 are closed, the power source 402 charges the charge storage device 408 to its maximum voltage, and the SIDAC 410 behaves as a switching device that transfers this charge to the resistor 412, which ignites the ignitable material through heat and/or sparks, which leads the ignition process in the weld metal mixture. In one instance, the ignited ignitable material provides a minimum energy required for initiating the self-propagating exothermic chemical reaction. The exothermic reaction can be heat, particular material, spark, air gapped pulse or any form of kinetic energy, mechanical energy, electrical energy or any form of energy.

FIG. 5 illustrates a non-limiting embodiment of the ignition device 106 in which the SIDAC 410 is omitted. FIG. 6 illustrates a non-limiting embodiment of the ignition device 106 in which the SIDAC 410 and the charge storage device 408 are omitted. In another embodiment, only the charge storage device 408 is omitted. In another embodiment, the manual switch 406 is omitted. Reducing components of the igniter 110 may reduce cost, complexity, and/or size. In other embodiments, one or more of the components in FIG. 4 can be omitted and/or one or more other components can be included. Such components include active and/or passive electrical components and/or other components. The source 402 can also be omitted. In this instance, a received high-energy pulse or data signal from the transmitter 102 can be used as the source.

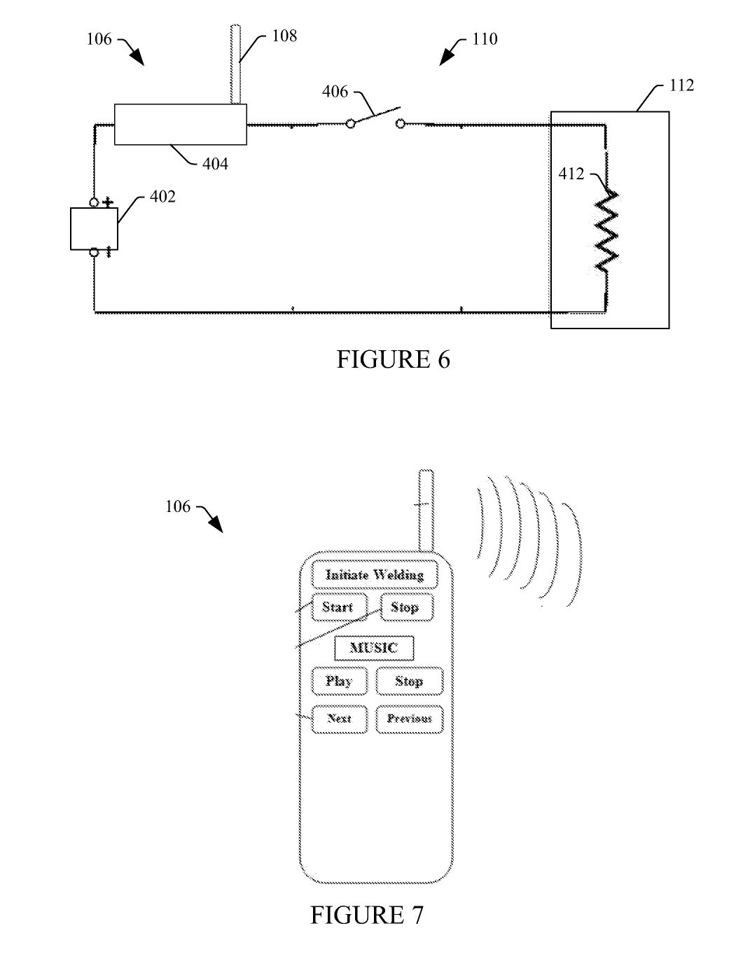

FIG. 7 illustrates a non-limiting embodiment of the transmitter 102. In this example, the transmitter 102 includes a computing device. The illustrated computing device is configured to transmit activation signals for the igniter 106. The illustrated computing device is also configured to play music stored in local or portal memory installed in the transmitter 102. In other embodiments, the transmitter 102 may had additional or different features such as the ability to send cell, text, instant messaging, etc. messages, capture and send still pictures or video, record sound, run computer executable applications, play video, display images, play sound, etc. In one instance, the transmitter 102 is configured so that a user can concurrently activate one or more igniter devices 106 and employ other functionality therein.

It is to be appreciated that ignition system describe herein may eliminate the use of starting powder and starting powder igniters, which are may be hazardous. However, a starting powder and/or starting powder igniter may be incorporated and/or used in connection with the system 100. In addition, the ignition system describe herein may allow an operator to initiate welding from a safe distance. Furthermore, the ignition system describe herein may provide a better weld quality and a stronger weld relative to other welding approaches. Furthermore, the ignition system describe herein may save labor and reduce work force cost. Furthermore, the ignition system describe herein may facilitate reaching not readily accessible areas and/or difficult locations. Furthermore, the ignition system describe herein may reduce installation time and make it easier to clean the mold after ignition.

Furthermore, the ignition system describe herein may lead to less risk of miss-use and easier identifying. Furthermore, the ignition system describe herein may provide greater flexibility and ease of use. Furthermore, the ignition system describe herein may provide conforming and homogenous welding results. Furthermore, the ignition system describe herein may also require few components and no need for flint guns. Furthermore, the ignition system describe herein may provide for unlimited welding processes per operation at the same time which all are controlled by one remote control system over traditional welding process which is a one-after-one welding process.

Furthermore, the ignition system describe herein can be applied to multiple molds at the same time and controlled by one remote control. Furthermore, the ignition system describe herein may also allow for faster welding initiation, which may eliminate worker's time and efforts. Furthermore, the ignition system describe herein can be programmed and controlled from home office/various locations without being present at the site and using advance tools like computers, sensors and others. Furthermore, the ignition system describe herein may provide more controllability options over traditional welding techniques.

Furthermore, the ignition system describe herein may provide consistency, reliability and accuracy over other traditional systems where they do not work most of the time. Furthermore, the ignition system describe herein may eliminate the repeating and trial process when the traditional system fails. Furthermore, the ignition system describe herein may provide for a cheaper and/or more cost competitive ignition system. Furthermore, the ignition system describe herein can be expanded to larger and wider industries. Furthermore, the ignition system describe herein could lead to superior laser welding technology.

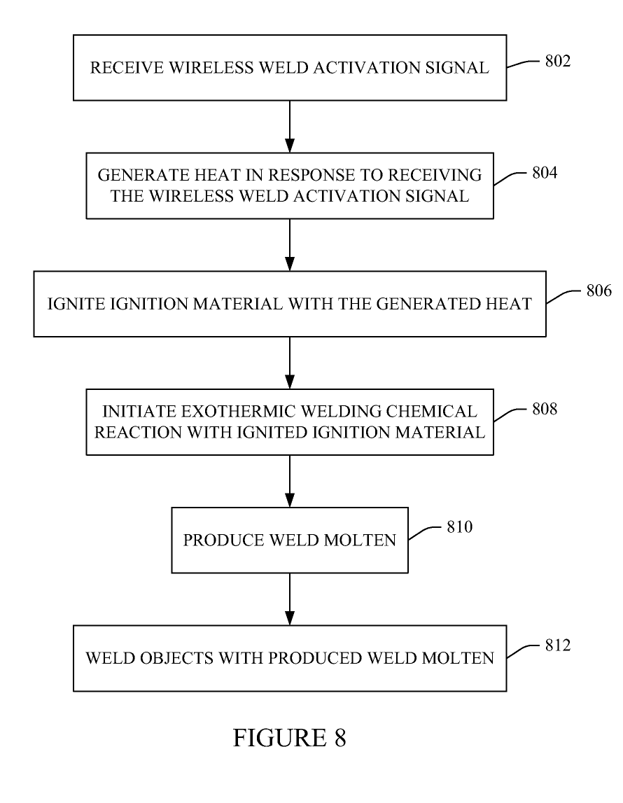

FIG. 8 illustrates a method for initiating exothermic welding.

At 802, a wireless weld activation signal is received.

At 804, in response thereto, heat is generated as described herein.

At 806, the heat is used to ignite an ignition material as describe herein.

At 808, an exothermic welding chemical reaction is initiated using the ignited ignition material.

At 810, the reaction produces a weld molten.

At 812, the weld molten is used to weld objects together.

The systems and methods described herein can be used in connection with Arc welding, welding guns, electrical welding process, and/or other welding applications.

The application has been described with reference to various embodiments. Modifications and alterations will occur to others upon reading the application. It is intended that the invention be construed as including all such modifications and alterations, including insofar as they come within the scope of the appended claims and the equivalents thereof.

1. A weld ignition system, comprising:
a wireless receiver that wirelessly receives a weld ignition activation signal; and
an igniter that ignites a weld ignition material in response to the wireless receiver wirelessly receiving the weld ignition activation signal, wherein the ignited weld ignition material initiates exothermic based welding of a weld material.

2. The system of claim 1, the igniter, comprising:
a switch that closes an electrical path in response to the wireless receiver wirelessly receiving the weld ignition activation signal;
an energy source that the supplies energy to components in the electrical path; and
an igniter material, in the electrical path, that absorbs the supplied energy and dissipates heat, wherein the dissipated heat initiates the exothermic based welding.

3. The system of claim 2, wherein the heat ignites the weld ignition material, and the ignited weld ignition material ignites the weld material.

4. The system of claim 1, wherein the igniter is configured to be placed at least partially within a weld mold holding the weld material.

5. The system of claim 4, wherein the igniter is located on a side of the weld mold.

6. The system of claim 4, wherein the igniter is part of the weld mold.

7. The system of claim 1, wherein the igniter and the weld material are included in a same package.

8. The system of claim 1, wherein the igniter is expendable, thereby being consumed.

9. The system of claim 1, wherein the igniter is reusable.

10. The system of claim 1, further comprising:
a transmitter (102) that transmits the weld ignition activation signal.

11. The system of claim 1, wherein the ignition material includes an electrical component.

12. The system of claim 1, wherein the ignition material includes a resistor.

13. A method, comprising:
initiating a self propagating exothermic welding chemical reaction based on wirelessly receiving a weld activation signal.

14. The method of claim 13, comprising:
generating heat in response to wirelessly receiving the weld activation signal;
igniting an ignition material with the heat; and
initiating the reaction with the ignited ignition material.

15. The method of claim 14, comprising:
supplying energy to a component that absorbs energy and dissipates heat in response thereto to generate the heat.

16. The method of claim 15, wherein the component and the ignition material are in a same device.

17. The method of claim 15, wherein the component, the ignition material, and a weld material of the reaction are in a same device.

18. The method of claim 16, wherein the same device is consumed.

19. The method of claim 16, wherein the same device is re-used.

20. A weld ignition system, comprising:
a transmitter that wirelessly transmits a weld ignition activation signal in response to an input;
a wireless receiver that wirelessly receives the weld ignition activation signal; and
an igniter that initiates an exothermic welding application based on the reception of the weld ignition activation signal.
